(19) United States
(12) Patent Application Publication
(10) Pub. No.: US 2018/0266839 A1
(43) Pub. Date: Sep. 20, 2018

(54) Process and system in which the user can provide additional criteria to select for the most preferable routes through Google Maps

(71) Applicant: Pamela Tajnai, Pewaukee, WI (US)

(72) Inventor: Pamela Tajnai, Pewaukee, WI (US)

(21) Appl. No.: 15/461,544

(22) Filed: Mar. 17, 2017

(51) Int. Cl. G01C 21/34; G01C 21/36

(52) U.S. Cl. CPC G01C 21/3484; G01C 21/3635; G01C 21/3614; G01C 21/3461; G01C 21/362

(57) ABSTRACT

This current invention is a system and app uses information provided by Google API data packets to screen for travel routes with undesired characteristics. Service user creates a route by inputting a start location and a destination, then approving of or rejecting characteristics of a route, such as distance, estimated time of arrival, construction, or traffic congestion. Service will then provide only routes that match all criteria. User can save routes and route settings. User can report conditions along route. Users can share routes and view routes shared by others.

### CROSS-REFERENCES TO RELATED APPLICATIONS (IF ANY)

None

### BACKGROUND

### 1. Field of the Invention

The present invention relates to a process to generate and select travel routes that are based on specific user criteria.

### 2. Description of Prior Art

Google Maps can be accessed through a standard web browser or with a mobile device application. A user can use a GPS location or input a starting point, as well as an end destination. Multiple destinations can be included, in any order the user desires. Google Maps provides multiple routes, with information about tolls, distance, traffic congestion, and estimated time of travel. The user can then modify a route by requiring it goes through a certain spot, and Google Maps will respond to the new route demands.

Other mapping services exist and do similar services. Commercially available portable GPS mapping devices (such as TomTom or Garmin devices) also do this, producing a route to an end destination, based on current location. They often have an option to avoid toll roads.

There is still room for improvement in the art.

### SUMMARY OF THE INVENTION

The current invention is system and application in which the user can request travel routes that meet individualized criteria. The system will only display routes that meet all the criteria, so the user doesn't need to view each route to determine viability. Qualifications for a route can include criteria such as current traffic conditions, construction, bridges, toll routes, land marks, or even routes shared by others.

The system, in the preferred embodiment, would work like a smartphone application, this product would be available through the respective marketplace for smartphones.

The process would be that a user would register and login. They can modify their profile, search for places, access saved routes, or generate new routes. When a new route is generated, a route can be created with no qualifiers. With a new or saved route, qualifiers can be added before creating a final map. Once the current location, destinations, and qualifiers are inputed, a final route is generated. The route can be viewed as a street map, in a 3-D view, or as a step-by-step set of directions. The process would continue to receive updated route information through Google Maps API provided data. When an update affects the current route, the user is alerted and can change the route. The user can also report updates of current conditions.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 displays a system diagram;

FIG. 3 shows the Login screen;

FIG. 4 shows the Register screen;

FIG. 5 shows the Change Password screen;

FIG. 6 shows the navigation options with the Menu open;

FIG. 7 shows the top of the Profile screen;

FIG. 8 shows the bottom of the Profile screen;

FIG. 9 shows the Saved Routes screen;

FIG. 10 shows the Route Overview screen;

FIG. 11 shows the New Route details screen (used when finding a route);

FIG. 12 shows the Edit Route details screen (used to modify a route);

FIG. 13 shows the Map Display screen; and

FIG. 14 shows the Edit View screen.

### DESCRIPTION OF THE PREFERRED EMBODIMENT

There are a number of significant design features and improvements incorporated within the invention.

The current invention is a system and application that would allow user to have greater customization of qualifying conditions that a Google Maps generated travel route must meet.

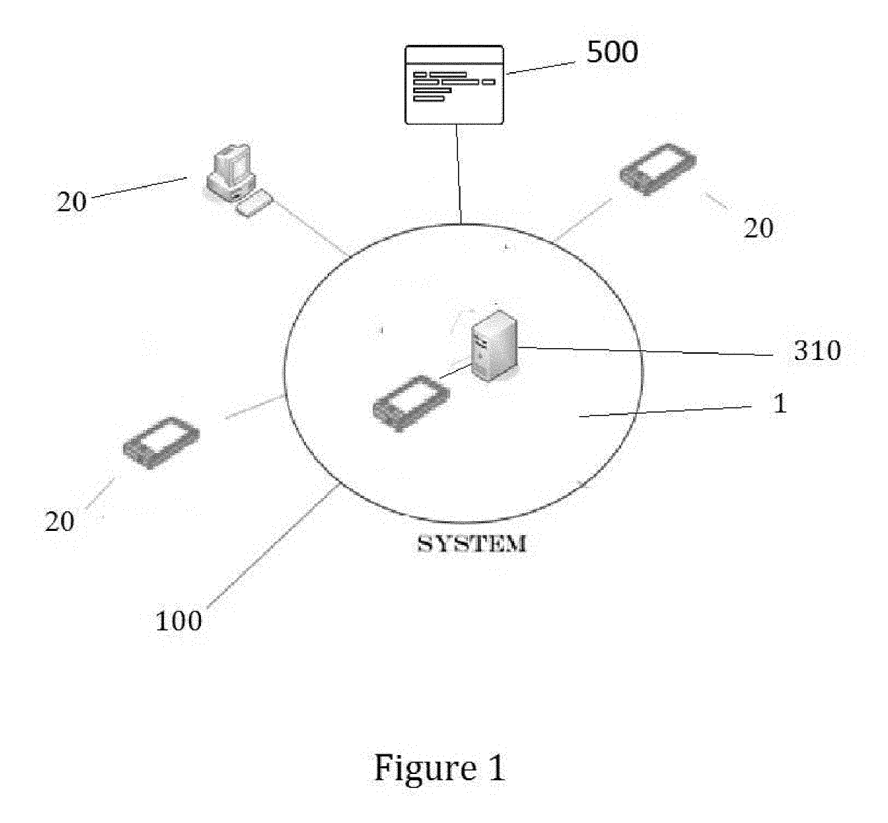

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 20 through a web browser over HTTP and/or HTTPS protocols 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app).

While Google Maps allows users to see current conditions of roads along the travel routes generated, the system 1 will eliminate routes that don't meet the user's selected criteria for travel route conditions. These factors can include distance, estimated time of arrival, traffic conditions, avoiding highway/freeway/motorway, avoiding ferries, and any other data Google provides. Users can report updates based on travel conditions. The system 1 would alert user to updated information and allow the user to find alternate routes. The system 1 will include each user feature separate from the other or combined.

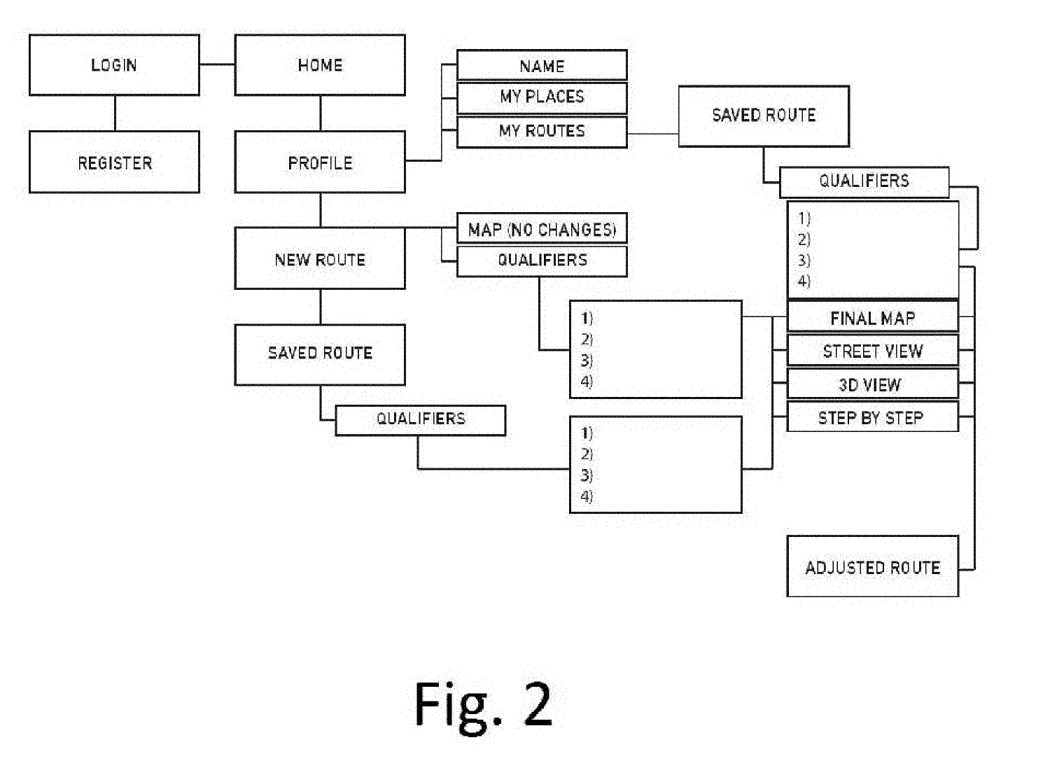

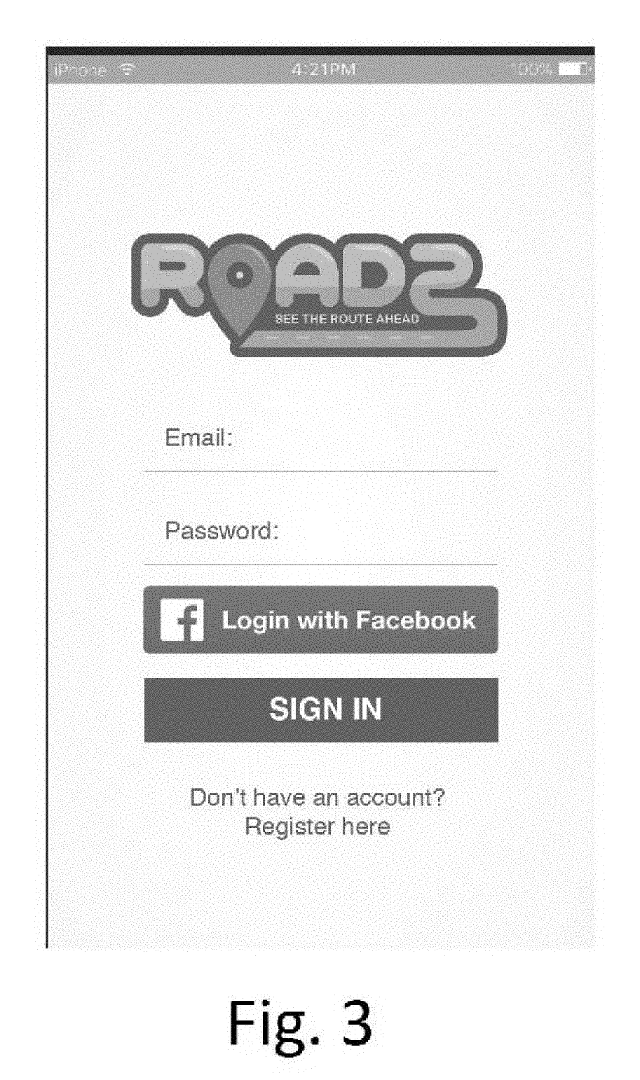

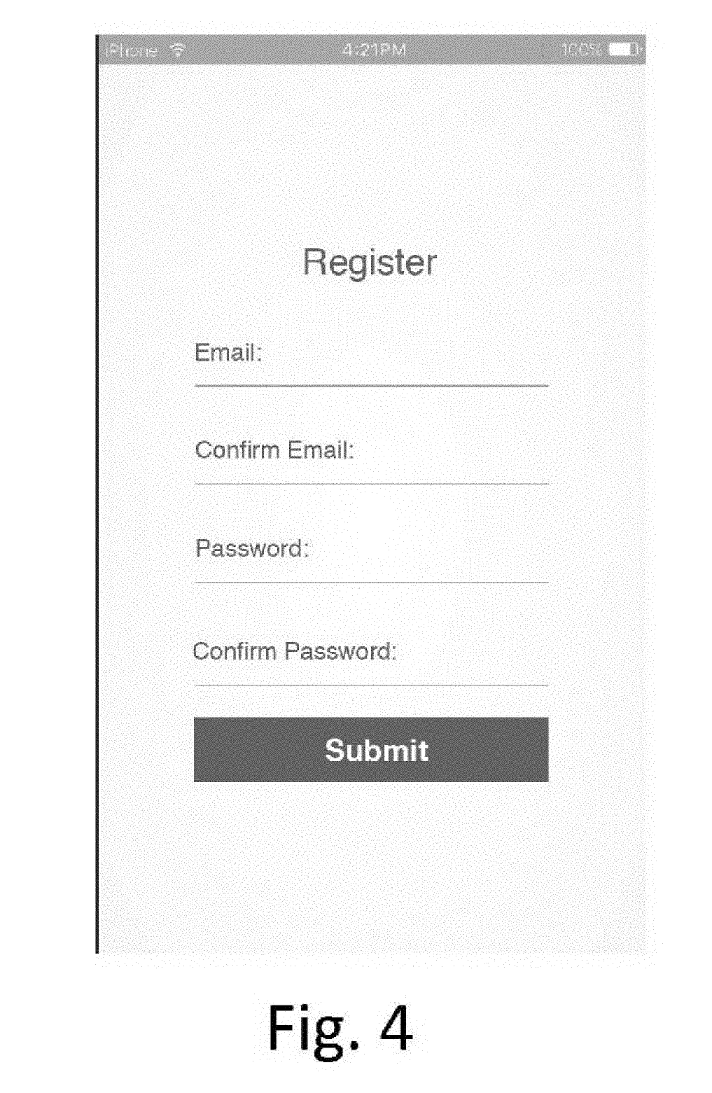

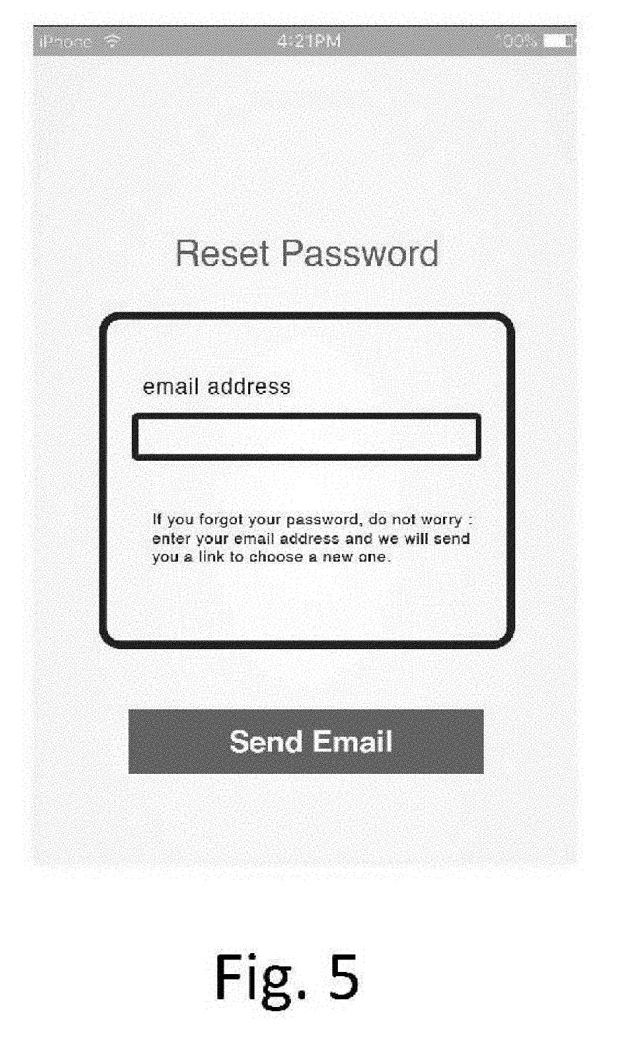

FIG. 2 shows the logic flow of the system 1. The users would sign-in directly or using social logins as shown in FIG. 3 with the user registering the app as shown in FIG. 4. The user can change password as shown in the Change Password screen is shown in FIG. 5.

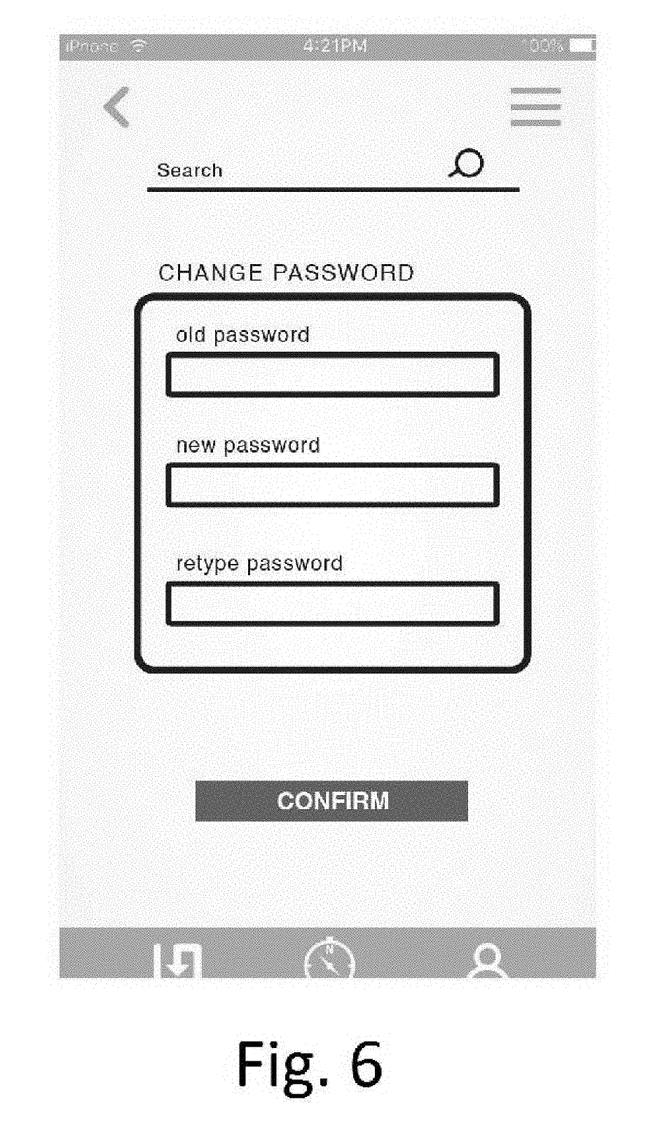

Once logged-in, the user has several navigations options, as shown in FIG. 6. The Menu in the top right has links to Settings (menu title)/Profile (page title) and Logout. At the bottom, a taskbar has links for (from left to right) Saved Routes, Map Screen, and networks/user sharing.

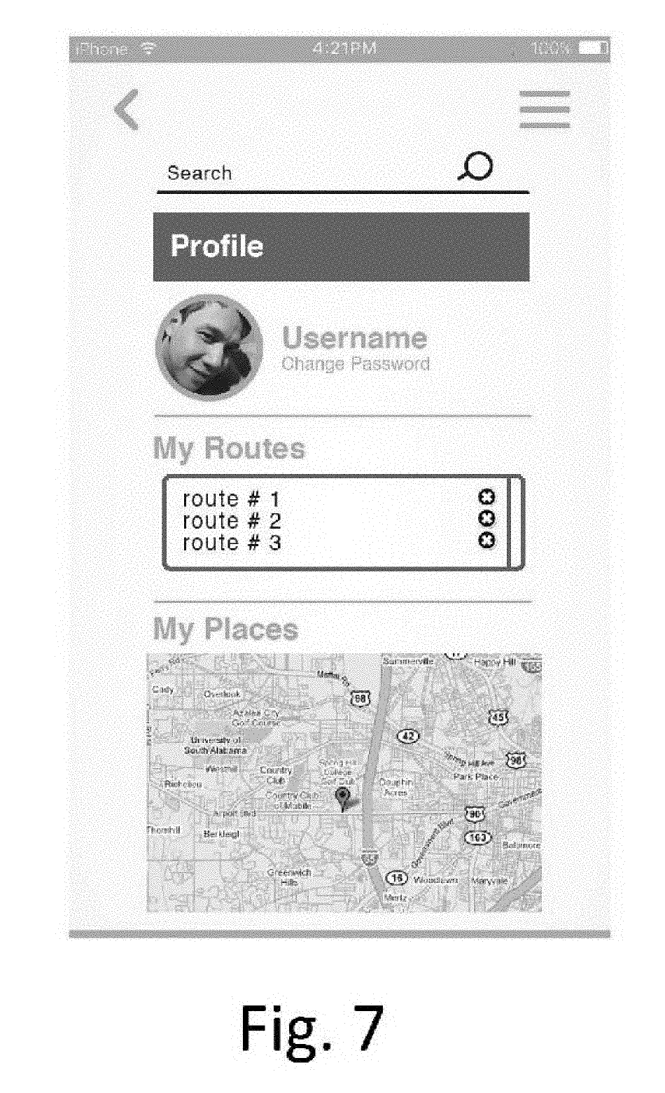

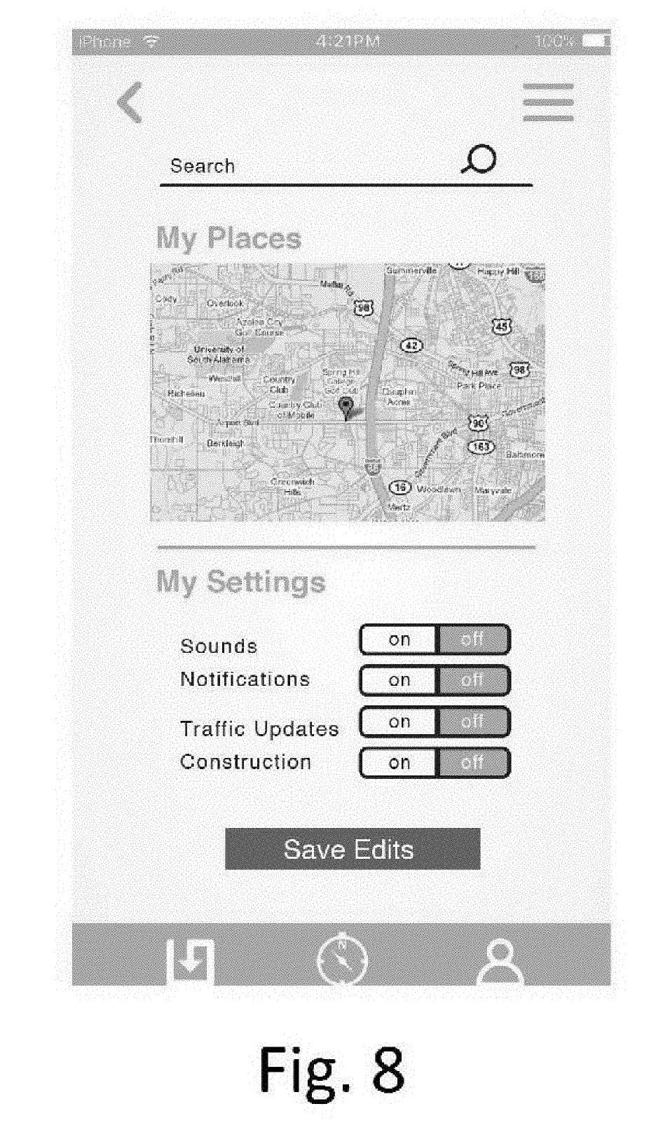

Settings/Profile, FIGS. 7 and 8, shows profile image and username, links to Change Password, shows Saved Routes, My Places, allows user to search for places, and displays and allows editing of settings such as Sounds, Notifications, Traffic Updates, and Construction updates.

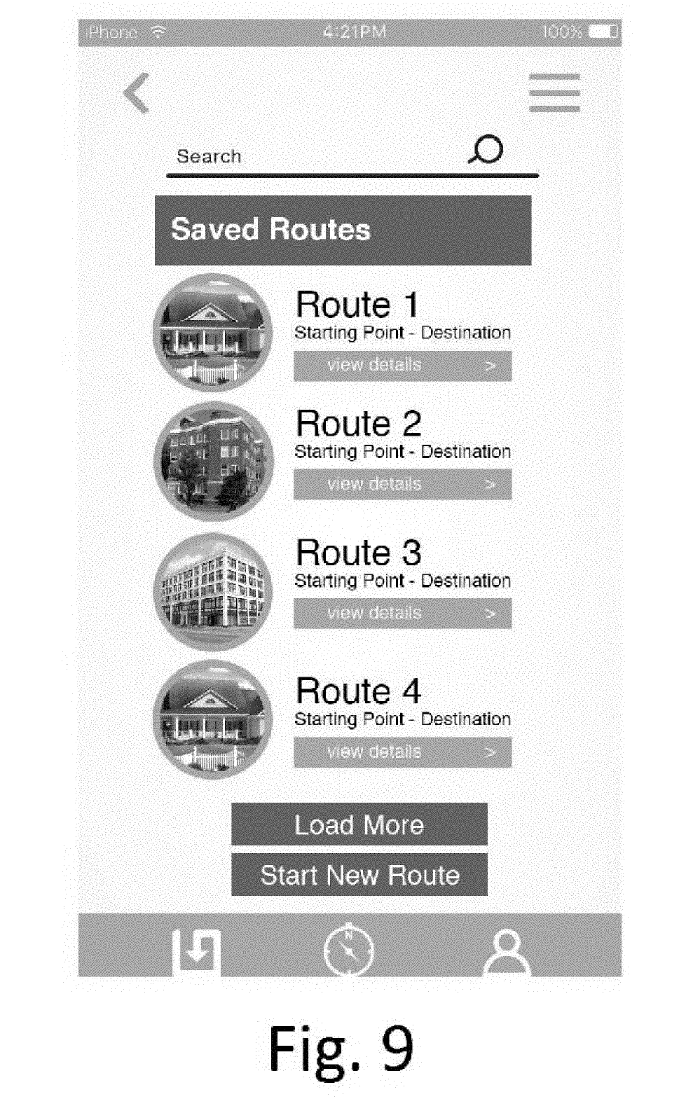

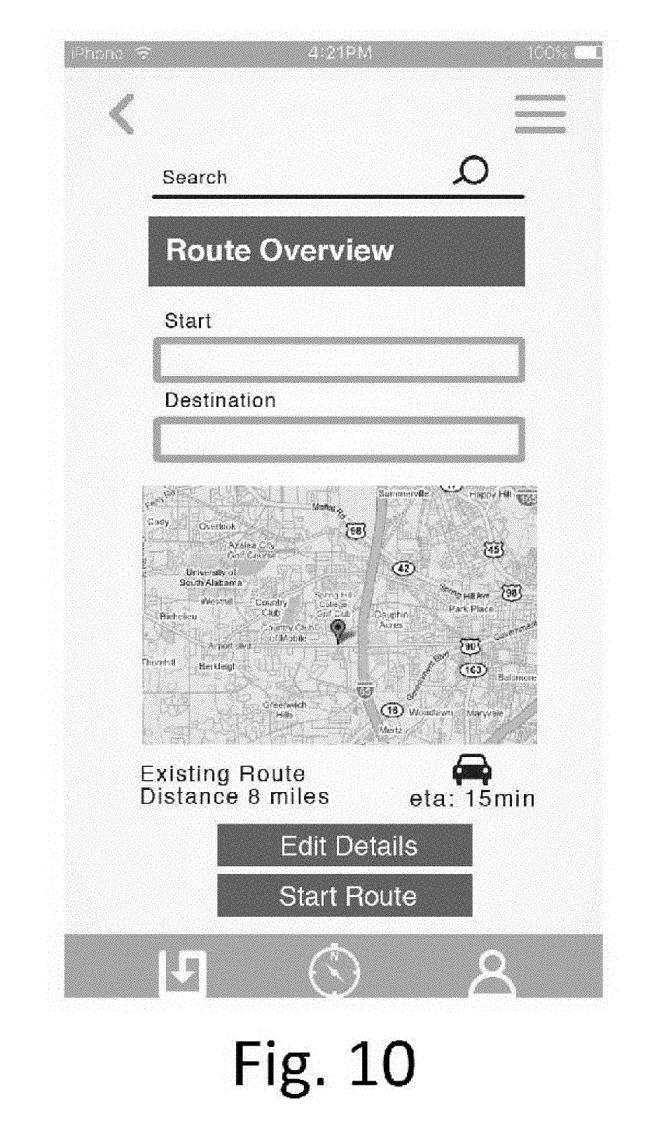

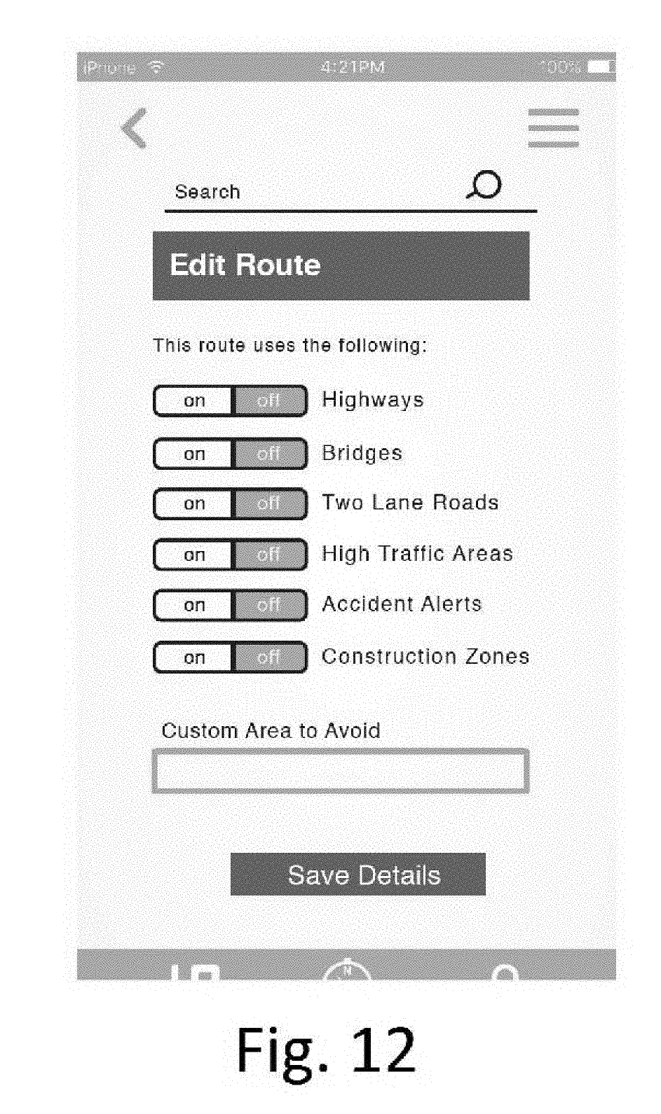

Saved Routes, as shown in FIG. 9, allows user to select previously created and saved routes, view the routes' details, as well as link to start a new route. When a saved route is selected, the Route Overview (FIG. 10) page is opened, with the saved route's start location, destination, and preferences applied. When a saved route's “view details” is clicked, the user is directed to the Edit Route screen (FIG. 12).

When the user clicks to create a new route they are directed to the Route Overview without any prior information loaded (FIG. 10).

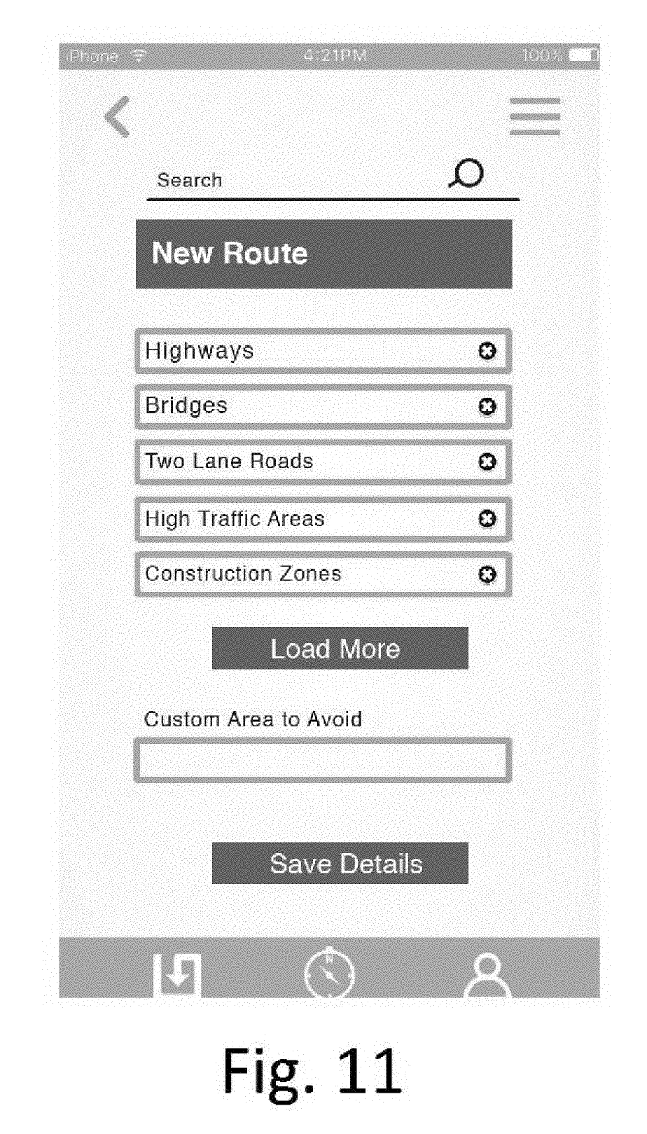

As shown in FIG. 10, the Route Overview page allows the user to input the starting location and the destination. A route is displayed, showing distance and estimated time. There are options to either edit details of the route or to start the route. When a new route is created, user is shown the New Route Detail page, FIG. 11, displaying what qualifiers a route has, allow user to not permit qualifiers and to add areas to avoid, as shown in FIG. 9. If user does not permit a qualifier or adds an area to avoid, an alternative route will be generated based on new criteria and the process repeats. Permitted criteria of a route can be modified later in the Edit Route screen, as shown in FIG. 12.

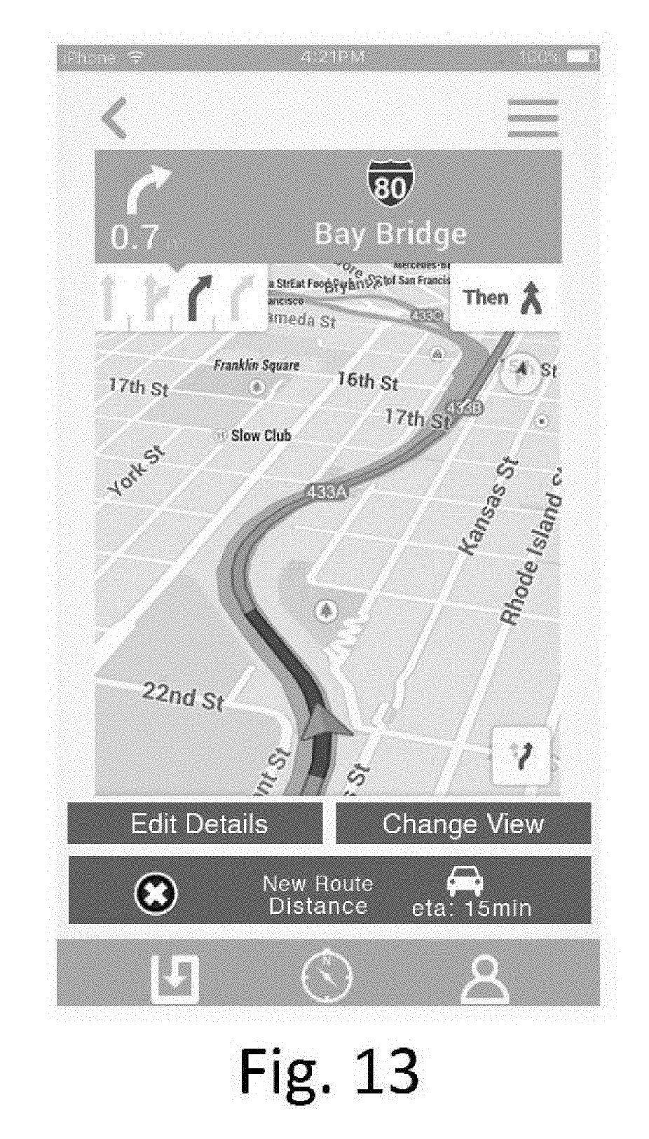

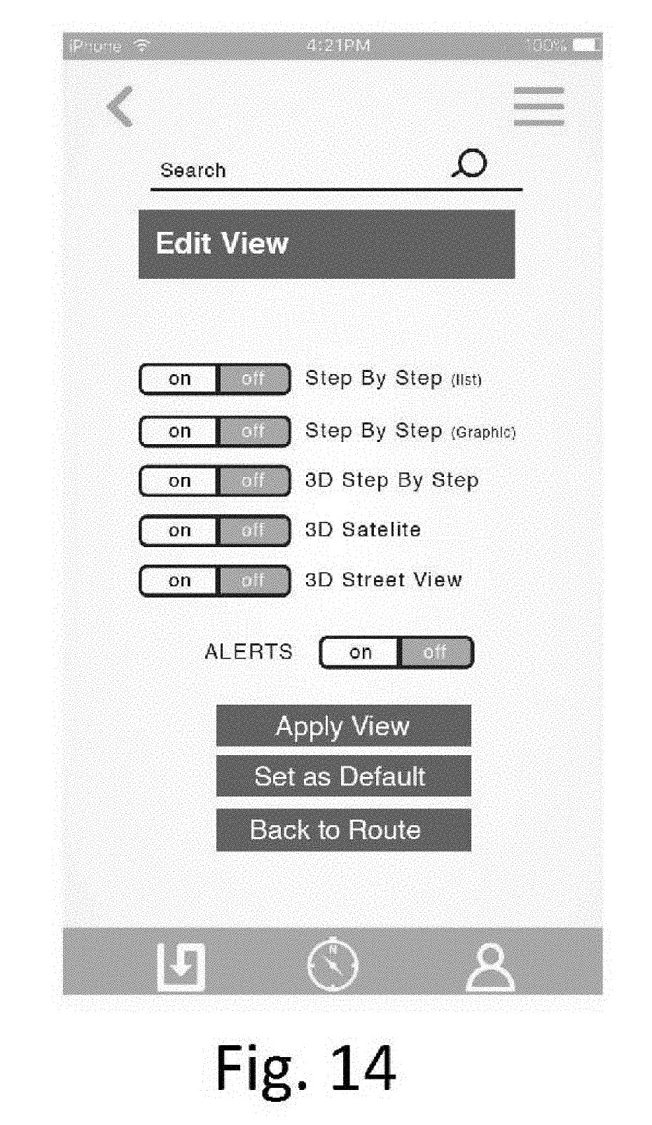

When the user selects to use a route, the user moves to the Final Map to receive directions, as shown in FIG. 13. The user can select “change view” to be directed to Edit View. In Edit View, the user can change map display features and alerts, as shown in FIG. 14.

Operation

The user can select criteria to pre-screen travel routes provided by Google Maps. User can select if they wish to view routes that contain elements such as construction or traffic problems, as provided by Google API. User inputs start and end locations, approves of desired route or rejects certain characteristics of the route. The user can change settings of the route at a later time.

The system 1 can provide each feature either separately or combined together.

Conclusion

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
using a map program;
input criteria;
creating a route based on that criteria; and
displaying the route.

2. A system according to claim 1 where the system is used with a smartphone.

3. A system according to claim 1 where the system is used with a tablet.

4. A system according to claim 1 where the system is used with a computer.

5. A system according to claim 1 where the criteria is one or more of a set distance, estimated time of arrive and travel route conditions.

6. A system according to claim 1 further comprising having route display as a screen image.

7. A system according to claim 1 further comprising having route display as a 3-D image

8. A system according to claim 1 where the user logs into the system using an ID and password.

9. A system according to claim 1 where the distance and estimated time is displayed.

10. A system according to claim 1 where the route can be stored.

11. A system according to claim 1 where the route can be modified.

12. A system according to claim 1 where the user creates a profile.

13. A system according to claim 12 where the profile can be edited.

14. A system according to claim 12 where the settings function allows the editing of the profile, herds and notification.

15. A system according to claim 1 where the user can add a plurality of areas to avoid.

16. A system according to claim 1 where the system is run on a website.
